(19) United States
(12) Patent Application Publication
(10) Pub. No.: US 2009/0197444 A1
(43) Pub. Date: Aug. 6, 2009

(54) Protection Cap and Combination of a Connector and a Protection Cap

(76) Inventor: Roland Tristan De Blieck, Et Oss (NL)

Correspondence Address: Harrington & Smith PC, 4 Research Drive, Suite 202, Shelton, CT, 06484, US

(21) Appl. No.: 12/084,076

(22) PCT Filed: Oct. 25, 2005
(86) PCT No.: PCT/EP2005/013017

§ 371 Date: Feb. 17, 2009

(51) Int. Cl. H01R 13/44; H01R 43/20

(52) U.S. Cl. 439/149; 29/747

(57) ABSTRACT

The invention relates to a protection cap for protecting at least a portion of leads of a connector. The comprises a top surface (T) and a bottom surface (B) and side walls (S) joining said top surface and bottom surface. The to surface has a first series of openings elongated in a first direction (I) and the bottom surface has a second series of openings elongated in a second direction (II). The opening of the second series are each arranged to receive at least portions of one or more of said leads when said cap is positioned over said leads. The first direction of said first series of openings makes an angle with said second direction of said second series of openings. The invention further relates to a combination of a protection cap and a connector and to a method for mounting a connector on a substrate.

### FIELD OF THE INVENTION

Generally, the invention relates to the field of electrical connectors. More particularly, the invention relates to a protection cap for protecting electrical connector mating pins during shipment, handling, processing and/or insertion of the electrical connectors.

### BACKGROUND OF THE INVENTION

A male, plug or header electrical connector typically includes an arrangement of electrical contacts or mating pins. During handling and shipment of the electrical connector, exposed end portions of the mating pins tend to bend.

Consequently, during mating, the bent pins do not match up with the corresponding receptacle connector contacts. The electrical connector, therefore, cannot be properly seated. That is, not all the mating pins of the electrical connector will engage properly the complementary contacts of the receptacle connector. In many cases, a damaged electrical connector can ruin an entire motherboard or daughtercard. Thus, there is a need in the art for a cap protecting the leads or pins or an electrical connector during handling and shipment.

Since the protection caps are typically only used until operation of the electrical connector, these protection caps should be inexpensive as the caps will normally be disposed after use. Further, it would be advantageous if the protection caps would be capable of withstanding considerable forces enabling the cap to be used as a pressure tool for insertion of the leads of the connector in substrate openings. For leads with press-fit contacts, these forces may be as large as 45 Newtons per contact.

### SUMMARY OF THE INVENTION

It is an object of the invention to provide an improved protection cap for protecting mating pins of an electrical connector.

It is a further object of the invention to provide a low-cost protection cap.

It is still a further object of the invention to provide a protection cap capable of resisting considerable forces.

The invention provides a protection cap for protecting at least a portion of leads of a connector. The cap comprises a top surface and a bottom surface and sidewalls joining said top surface and bottom surface. The top surface has a first series of openings elongated in a first direction and said bottom surface has a second series of openings elongated in a second direction. The openings of the second series are each arranged to receive said portions of one or more of said leads when said cap is positioned over said leads. The first direction of said first series of openings makes an angle with said second direction of said second series of openings.

The invention further provides a combination of a protection cap and a connector having a plurality of leads disposed in a housing. The cap comprises a top surface and a bottom surface and sidewalls joining said top surface and bottom surface. The top surface has a first series of openings elongated in a first direction and said bottom surface has a second series of openings elongated in a second direction. The openings of the second series are each arranged to receive at least proximal portions of one or more of said leads when said cap is positioned over said leads. The first direction of said first series of openings makes an angle with said second direction of said second series of openings.

The protection cap is a low-cost protection cap as the openings in the top surface save material and reduce the weight of the protection cap which makes it easier to handle and ship. Furthermore, since the orientation of the elongated openings in the top surface and bottom surface is different, a mechanically rigid protection cap is provided. Such a rigid protection cap is capable of being exposed to insertion forces or insertion of the contact portions of the leads into a substrate. Consequently, the cap fulfils the double function of a protection means for a connector and a press tool.

The embodiment of the invention as defined in claim 2 is advantageous in that it improves the mechanical rigidity of the cap.

The embodiment of the invention as defined in claim 3 has the advantage of a very low-cost cap, since the amount of material is reduced. Furthermore, the weight of the cap is reduced.

The embodiment of the invention as defined in claim 4 has the advantage of avoiding exposure of the mating pins to dust and dirt.

The embodiment of the invention as defined in claim 5 has the advantage of a mechanically rigid protection cap that can be manufactured relatively easily. However, the elongated openings may comprise oval openings or stretched diamond shaped openings.

The embodiment of the invention as defined in claim 6 provides guiding ribs for guiding the cap on application on a connector.

The embodiments of the invention as defined in claims 7 and 13 have the advantage of providing means for handling the cap and/or for means for mounting a cap or a combination of a cap and a connector in a container.

The embodiment of the invention as defined in claim 8 has the advantage of providing a means for fixating the cap on the connector.

The embodiment of the invention as defined in claim 9 has the advantage of means ensuring that the cap is correctly positioned on the connector to avoid bending of the leads on application of the cap or on application of a force on the cap.

The invention further provides a protection cap for protecting at least portions of leads of a connector. The cap comprises a top surface and a bottom surface and sidewalls joining said top surface and bottom surface. The top surface has a first series of rectangular opcnings elongated in a first direction and said bottom surface has a second series of rectangular openings elongated in a second direction. The openings of the second series are each arranged to receive at least portions of one or more of said leads when said cap is positioned over said leads. The openings in the bottom surface are connected to said openings in said top surface to form through-holes in said cap. The first direction of said first series of openings is substantially perpendicular to said second direction of said second series of openings.

The embodiment of the invention as defined in claim 12 provides for an efficient force transfer structure to transfer an insertion force applied to the top surface of the cap to the connector.

The embodiment of the invention as defined in claim 14 provides for a unlocking means for disposal of the protection cap.

The embodiment of the invention as defined in claim 15 defines connector contacts of the connector that require a considerable insertion force for the contacts to be inserted into substrate openings.

The embodiment of the invention as defined in claim 16 provides the advantage that handling, positioning and insertion of the connectors in a substrate is facilitated.

The invention further provides a container comprising a plurality of combinations of a connector and a protection cap as described above.

The container provides a suitable packaging for shipping of the combinations.

The invention also provides a method for mounting a connector with a plurality of leads on a substrate having substrate openings for said leads. The connector has a protection cap for protecting at least portions of said leads. The cap comprises a top surface and a bottom surface and sidewalls joining said top surface and bottom surface. The top surface has a first series of openings elongated in a first direction and said bottom surface has a second series of openings elongated in a second direction. The openings of said second series are each arranged to receive at least portions of one or more of said leads when said cap is positioned over said leads. The first direction of said first series of openings makes an angle with said second direction of said second series of openings. The method comprises the steps of:
applying a force on said top surface for inserting portions of said leads into said substrate openings, and
removing said protection cap.

The embodiment of the invention as defined in claim 19 provides the advantage that handling, positioning and insertion of the connectors in a substrate is facilitated.

The invention will be further illustrated with reference to the attached drawings, which schematically show preferred embodiments according to the invention. It will be understood that the invention is not in any way restricted to these specific and preferred embodiments.

### BRIEF DESCRIPTION OF THE DRAWINGS

In the drawings:

FIGS. 1A and 1B respectively show perspective views of the top surface and the bottom surface of a protection cap according to an embodiment of the invention;

FIG. 2 shows a perspective view of the protection cap of FIGS. 1A and 1B about to be applied on a connector;

FIG. 3 shows a cross-section of the protection cap of FIGS. 1A and 1B applied on the connector.

FIG. 4 shows a cross-section of a protection cap according to a further embodiment of the invention.

FIG. 5 shows a schematic illustration of a non-perpendicular orientation of the openings in the top surface and bottom surface of the protection cap;

FIG. 6 shows a schematic illustration of a container comprising combinations of a protection cap and a connector according to an embodiment of the invention, and

FIG. 7 shows a schematic illustration of a protection cap applied on a plurality of connectors.

### DETAILED DESCRIPTION OF THE DRAWINGS

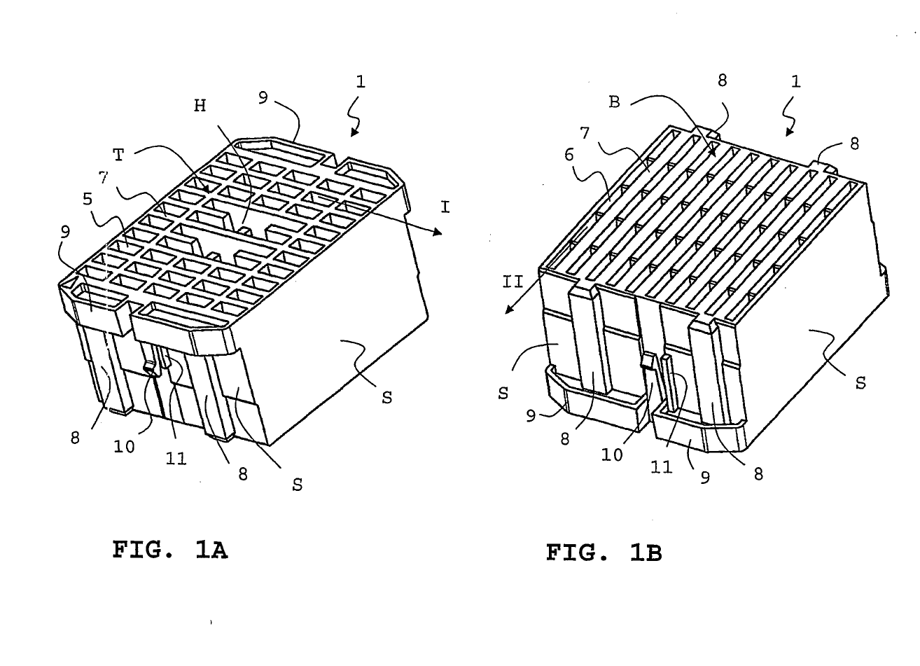

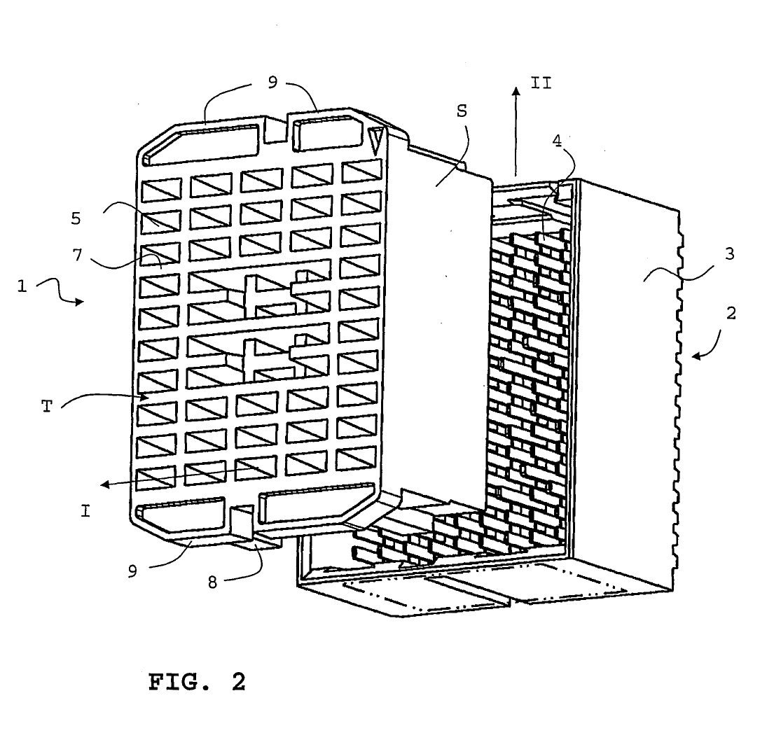

FIGS. 1A and 1B respectively show perspective views of the top surface T and the bottom surface B of a disposable protection cap 1 according to an embodiment of the invention. FIG. 2 shows the protection cap 1 just before application of the cap 1 on a connector 2 having a housing 3 with leads 4.

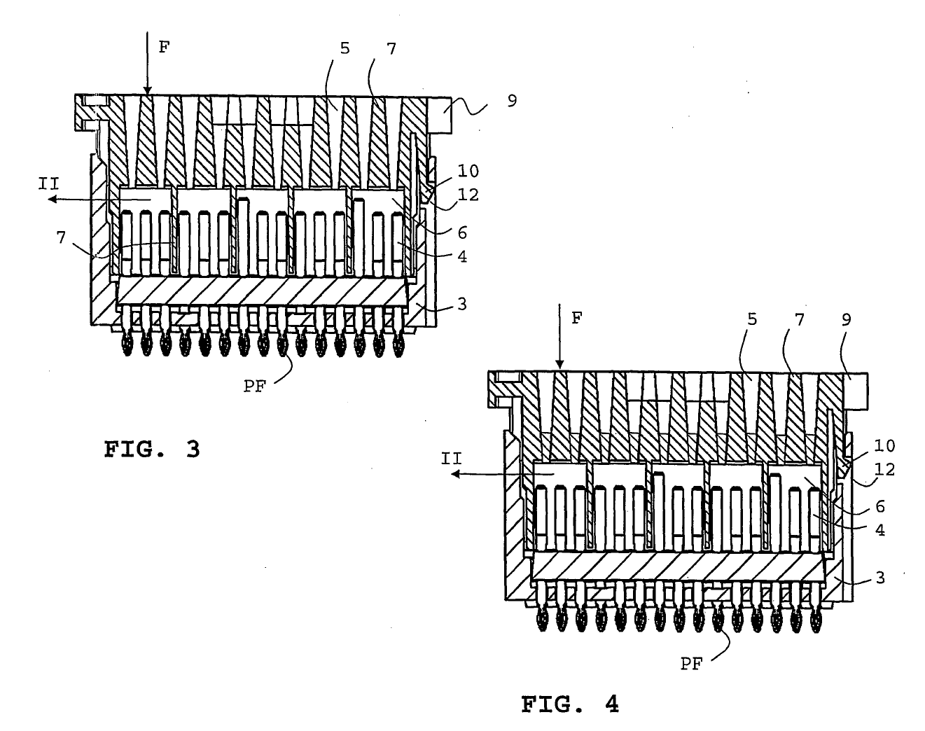

The protection cap 1 has sidewalls S joining the top surface T and the bottom surface B. The top surface T has a first series of openings 5 elongated in a first direction I. As the openings may be very small, a structure H is provided in the top surface T of the protection cap 1 to enable handling of the cap with a gripping tool. Such a gripping tool may be required to remove the cap 1 from the connector, if there is no room for handling the cap manually, e.g. because further connectors are too close to the connector with the cap 1 to allow manual handling. The bottom surface B has a second series of openings 6 elongated in a second direction II. The second series of openings 6 are arranged to receive portions of one or more of the leads 4 of the connector 2 when the protection cap 1 is positioned over these leads L, as most clearly illustrated in FIGS. 3 and 4.

In the embodiment of FIGS. 1A-3, the first direction I of the openings 5 in the top surface T of the protection cap 1 is perpendicular to the second direction II of the openings 6 in the bottom surface B of the protection cap 1. It should be appreciated, however, that more generally the elongation directions I,II of the holes 5,6 in respectively the top surface T and bottom surface B of the protection cap 1 may define any angle α between 0° and 90°, such as 45° or 60°, as illustrated in FIG. 5 showing a planar projection of only the openings 5,6. The directions I,II are preferably defined in substantially parallel planes comprising the top surface T and bottom surface B.

Moreover, it is to be noted that, although the embodiment of FIGS. 1A-3 discloses rectangular openings 5,6 defined by ribs 7, other shapes for the openings 5,6 having a specific orientation, including oval shapes as schematically shown in projection in FIG. 5, ha-e been contemplated by the applicant.

The protection cap 1 further has guiding ribs 8 extending over the sidewalls S between the bottom surface B and the top surface T. These ribs 8 guide the cap 1 when the cap 1 is mounted on the connector 2.

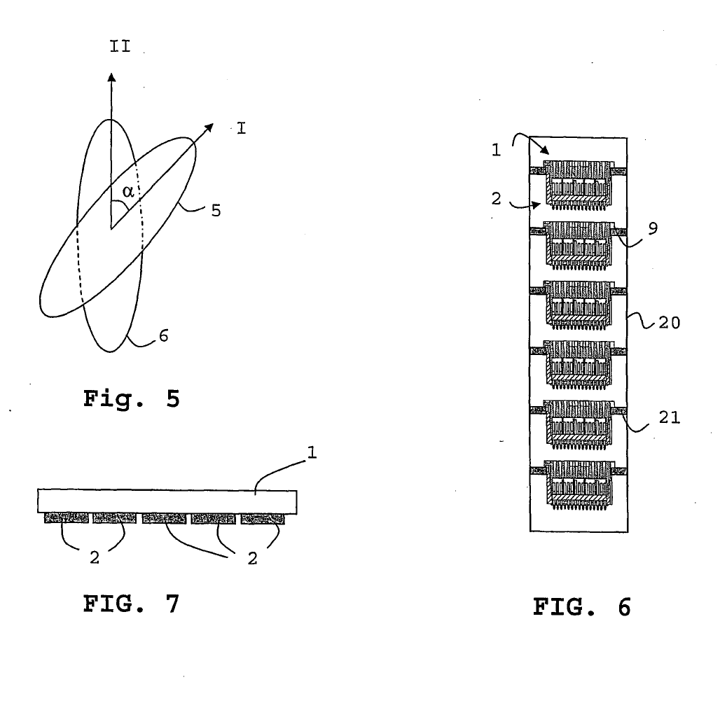

The protection cap 1 has projections 9 extending outwardly from the sidewalls S for (manual) handling purposes. The projections 9 further serve to hold caps 1 or combinations of a cap 1 and a connector 2 within a container as illustrated in FIG. 6.

Furthermore, the protection cap 1 comprises a fixation latch 10 to latch the cap 1 on the connector 2, as illustrated in FIGS. 3 and 4. It should be appreciated that other variants for fixating the cap 1 and connector 2 have been envisaged, including a latch in the connector 2 and a receiving structure in the cap 1 or a friction force fixation arrangement.

The protection cap 1 also has a polarizing structure 11 to define the correct orientation of the cap 1 with respect to the connector 2. It is to be noted that the polarizing structure 11 may be located at another position. Furthermore, for symmetrical connectors, a polarization structure 11 may be omitted.

Preferably, the protection cap 2 is of plastic material, such as polybutylene terephthalate (PBT). The dimensions of the cap 1 in the first direction I and the second direction II may be in the range of 10-20 mm and 15-30 mm respectively. However, the actual dimensions of the cap 1 depend on the size of the connector, such as the pitch of the leads.

The height of the cap 1, i.e. the distance between the top surface T and bottom surface B of the cap 1 may be in the range of 10-20 mm. In some cases the height of the cap 1 should be kept low, if a low height of the connector with the cap 1 applied is required. However, to accomplish a cap 1 of sufficient rigidity to function as a press cap, a minimal height is required. Further, as the leads of the connector 2 should be protected by the cap 1, the height of the cap 1 should be such that the leads do not protrude from the top surface T of the cap 1.

FIG. 3 shows a cross-section of the protection cap 1 of FIGS. 1A and 1B applied on the connector 2. The cap 1 partly intrudes the inner space of the housing 3 of the connector 2. The latch 10 locks the cap 1 in a corresponding opening 12 of the housing 3. The opening 12 is arranged to enable manipulation of the latch 10 to remove the protection cap 1 from the connector 2.

In operation, an insertion force F may be applied on the cap 1 to insert press-fit contacts PF of the leads 4 of the connector 2 into openings in a substrate (not shown). The angled orientation of the openings 5 and 6 in respectively the top surface T and bottom surface B of the cap 1 provides for an adequate mechanical rigidity of the cap 1 to transfer these insertion forces F from an insertion tool (not shown) to the press-fit contacts PF of the leads 4. Transfer of these forces F is accomplished via the ridges 7 and/or the sidewalls S of the cap 1 where these abut the connector 2. After insertion, the cap 1 can be removed by manipulating the latch 10 through the opening 12.

In the embodiment of FIG. 3, the openings 5 in the top surface T of the cap 1 are connected to the openings 6 in the bottom surface B of the cap 1 to form through holes. Consequently, a very low-cost and light-weight protection cap 1 is obtained.

In the embodiment of FIG. 4, the openings 5 in the top surface T of the cap 1 are blind holes. Consequently, the leads 4 of the connector 2 are protected against outside influences, including dust and dirt, as long as the protection cap 1 is on the connector 2.

FIG. 6 schematically illustrates a container 20 comprising a plurality of connectors 2 each protected by a protection cap 1 according to the embodiment of FIG. 3. The container 20 has means 21 for holding the combinations of a protection cap 1 and connector 2 that are adapted to cooperate with the extensions 9. It should be appreciated that the container 20 may included a significantly higher amount of combinations, e.g. fifty or hundred, than shown in FIG. 6.

Finally, in FIG. 7 a single protection cap 1 is schematically displayed applied on a plurality of connectors 2. Such an arrangement may be advantageous for handling, positioning and insertion of the connectors 2 in a substrate.

1. A protection cap for protecting at least a portion of leads of a connector, said cap comprising a top surface (T) and a bottom surface (B) and sidewalls (S) joining said top surface and bottom surface, wherein said top surface has a first series of openings elongated in a first direction (I) and said bottom surface has a second series of openings elongated in a second direction (II), said second series of openings each being arranged to receive at least portions of one or more of said leads when said cap is positioned over said leads, and wherein said first direction of said first series of openings makes an angle (α) with said second direction of said second series of openings.

2. The protection cap of claim 1, wherein said first direction (I) of said first series of openings is substantially perpendicular to said second direction (II) of said second series of openings.

3. The protection cap of claim 1, wherein one or more openings in said top surface (T) and one or more openings in said bottom surface (B) are connected to form through-holes in said cap.

4. The protection cap of claim 1, wherein one or more of said openings in said top surface (T) are blind holes.

5. The protection cap of claim 1, wherein said top surface (T) and bottom surface (B) comprise ribs defining rectangular openings in respectively said first and second direction.

6. The protection cap of claim 1, wherein said cap comprises one or more guiding ribs extending over said sidewalls (S).

7. The protection cap of claim 1, wherein said cap comprises cue or more projections extending outwardly from said sidewalls (S).

8. The protection cap of claim 1, wherein said cap comprises one or more fixation latches to latch said cap on said connector.

9. The protection cap of claim 1, wherein said cap comprises one or more polarizing structures.

10. A protection cap for protecting at least portions of leads of a connector, said cap comprising a top surface (T) and a bottom surface (B) and sidewalls (S) joining said top surface and bottom surface, wherein said top surface has a first series of rectangular openings elongated in a first direction (I) and said bottom surface has a second series of rectangular openings elongated in a second direction (II), said second series of openings each being arranged to receive at least portions of one or more of said leads when said cap is positioned over said leads and being connected to said openings in said top surface to form through-holes in said cap, and wherein said first direction of said first series of openings is substantially perpendicular to said second direction of said second series of openings.

11. A combination of a protection cap and a connector having a plurality of leads disposed in a housing, said cap comprising a top surface (T) and a bottom surface (B) and sidewalls (S) joining said top surface and bottom surface, wherein said top surface has a first series of openings elongated in a first direction (I) and said bottom surface has a second series of openings elongated in a second direction (II), said second series of openings each being arranged to receive at least portions of one or more of said leads when said cap is positioned over said leads, and wherein said first direction of said first series of openings makes an angle (α) with said second direction of said second series of openings.

12. The combination of claim 11, wherein said elongated openings in said bottom surface are defined by ribs and said sidewalls (S) and/or said ribs abut said connector to enable transfer of an insertion force to said leads.

13. The combination of claim 11, wherein said housing comprises a fixation structure adapted to cooperate with a fixation latch of said cap.

14. The combination of claim 13, wherein said combination has an opening capable of providing access for manipulating said fixation latch.

15. The combination of claim 11, wherein said leads comprise press-fit contacts (PP).

16. The combination of claim 11, wherein said protection cap accommodates two or more connectors.

17. A container comprising a plurality of the combinations of claim 11, wherein said cap comprises one or more projections extending outwards from said sidewalls (S) and said container has receiving structures for engaging with said projections to hold said combinations in said container.

18. A method for mounting a connector with a plurality of leads on a substrate having substrate openings for said leads, said connector having a protection cap for protecting at least a portion of said leads, said cap comprising a top surface (T) and a bottom surface (B) and sidewalls (S) joining said top surface and bottom surface, wherein said top surface has a first series of openings elongated in a first direction (I) and said bottom surface has a second series of openings elongated in a second direction (II), said second series of openings each being arranged to receive at least portions of one or more of said leads when said cap is positioned over said leads, and wherein said first direction of said first series of openings makes an angle (α) with said second direction of said second series of openings, said method comprising the steps of: applying a force (F) on said top surface for inserting portions (PF) of said leads into said substrate openings, and removing said protection cap.

19. The method of claim 18, wherein said protection cap accommodates more than one connector and said force (F) is applied on said top surface (T) for inserting portions (PP) of leads of more than one connector.
